(19) United States
(12) Patent Application Publication
(10) Pub. No.: US 2025/0389878 A1
(43) Pub. Date: Dec. 25, 2025

(54) METHOD FOR MANUFACTURING AN OPTICAL FILTER, OPTICAL FILTER SYSTEM, OPTICAL MEASUREMENT DEVICE AND USE

(71) Applicant: ADMESY B.V., Ittervoort (NL)

(72) Inventor: Wim WELTJENS, Ittervoort (NL)

(21) Appl. No.: 18/880,381

(22) PCT Filed: Jun. 28, 2023
(86) PCT No.: PCT/EP2023/067689

§ 371 Date: Dec. 31, 2024

(30) Foreign Application Priority Data
Jul. 1, 2022 (EP) 22182483.2

(51) Int. Cl. G02B 5/20; G01N 21/25

(52) U.S. Cl. CPC G02B 5/201; G01N 21/251

(57) ABSTRACT

The invention relates to a method for dicing a substrate coated with an optical filter coating. The first substrate is coated with an optical filter coating configured with a specific spectral sensitivity. The method comprises the steps of: forming a substrate stack by disposing a second substrate over the optical filter coating of the coated substrate such that the optical filter coating forms an interlayer between the first substrate and the second substrate; and dicing the substrate stack into a plurality of individual portions. Each portion comprises a part of the coated substrate and a part of the second substrate with a part of the optical filter coating as an interlayer in between the part of the first substrate and the part of the second substrate. The individual portions may serve as filters of an optical filter system. The optical filter system may be part of an optical measurement device.

### FIELD OF THE INVENTION

The invention relates to a method for manufacturing an optical filter. The invention relates to an optical filter system comprising the optical filter manufactured according to the method. The invention further relates to an optical measurement device comprising the optical filter system. The invention further relates to use of the optical measurement device.

### BACKGROUND

In various optical applications, optical filters are used. An optical filter is a device that transmits optical radiation, i.e., light, with certain wavelengths, whereas optical radiation with other wavelengths are blocked—in general blocked for about 100% but this is not always the case—from transmitting through the optical filter. By arranging an optical filter along an optical path, optical radiation travelling along the optical path may be directed or divided by the optical filter.

Optical filters are used in color measurements. For example, a typical colorimeter has three sets of filters, an X-set, an Y-set, and a Z-set. Each set of optical filters allows passage of a range of wavelengths according to a tristimulus value. One set allows passage of tristimulus value X (red), one set allows passage of tristimulus value Y (green), and one set allows passage of tristimulus value Z (blue).

An optical filter may be made by providing an optical filter coating onto a clear glass substrate. The optical filter coating determines the filter properties of the optical filter. The glass substrate provides a surface onto which the optical filter coating is applied. After the optical filter coating is applied to the glass substrate, the glass substrate is cut to obtain the optical filter with the desired shape and size. However, during the cutting of the glass substrate, chipping near the cutting edge may occur. The chipping damages the optical filter coating, which negatively affects the filter properties of the optical filter.

Chipping is the more a problem in case the desired size has very small dimensions, like 1 mm by 1 mm or smaller. With such small dimensions, chipping may take away a substantial part of the coating or possibly the entire coating. Damaged optical filter coating is the more a problem case the filter is to be used in combination with a photodiode and serves the purpose to allow passage of only light of a specific bandwidth to be measured by the photodiode. Damaged optical filter coatings then result in that the photodiode also measures other bandwidths and consequently gives incorrect measurement results.

### SUMMARY OF THE INVENTION

It is an objective of the invention is to provide a method for dicing a substrate coated with an optical filter. Another objective is to provide method for manufacturing an optical filter. A further other objective of the invention to provide an alternative and/or improved method to dice a substrate coated with an optical filter for use with an optical sensor, such as a photodiode. A further, other objective is to manufacture an optical filter for use with an optical sensor, such as a photodiode. A further other objective of the invention to provide a solution to one or more problems of the known art, or at least to provide an alternative solution.

One or more of these objectives are, according to a first aspect of the invention, achieved by a method for dicing a substrate coated with an optical filter coating, the method comprising the steps of:
providing a coated substrate comprising a first substrate coated with the optical filter coating configured with a specific spectral sensitivity;
forming a substrate stack by disposing a second substrate over the optical filter coating of the coated substrate such that the optical filter coating forms an interlayer between the first substrate and the second substrate;
dicing the substrate stack into a plurality of separated, individual portions, each portion comprising a diced part of the coated substrate and a diced part of the second substrate with a diced part of the optical filter coating as an interlayer in between the diced part of the first substrate and the diced part of the second substrate.
   The step of dicing may for example use a circular rotating saw disc.

One or more of these objectives are, according to a second aspect of the invention, achieved by a method for manufacturing an optical filter, the method comprising the steps of:
providing a coated substrate comprising a first substrate coated with an optical filter coating configured with a specific spectral sensitivity;
forming a substrate stack by disposing a second substrate over the optical filter coating of the coated substrate such that the optical filter coating forms an interlayer between the first substrate and the second substrate;
dicing the substrate stack into a plurality of separated, individual portions, each portion comprising a diced part of the coated substrate and a diced part of the second substrate with a diced part of the optical filter coating as an interlayer in between the diced part of the first substrate and the diced part of the second substrate, each portion providing basis for an optical filter.
   The step of dicing may for example use a circular rotating saw disc.

In an embodiment of the first and/or second aspect, the step of providing a coated substrate comprises the steps of:
providing a first substrate; and
applying an optical filter coating on the first substrate to obtain a coated substrate.
   The optical filter coating may for example be applied by sputter deposition, such as ion beam sputtering.

In an embodiment of the first and/or second aspect, the specific spectral sensitivity is configured for allowing passage of optical radiation at predefined wavelengths and preventing passage of optical radiation having wavelengths other than the predefined wavelengths. Such an embodiment may be used in a colorimeter requiring a specially designed filter designed for allowing specific parts—the predefined wavelengths—, like two or more separated parts, of a spectrum to pass while blocking other parts. Such an embodiment may also be used in so called band-pass filters in which the predefined wavelengths may for example have bandwidth of 10 nm or less. This bandwidth may for example be 5 nm or less. It is foreseen that the bandwidth may be 2.5 nm or less or even smaller like in the range of 1 nm or less.

In an embodiment of the first and/or second aspect, the optical filter coating may have an optical filter property that is representative of a range of wavelengths that are transmittable through the first substrate and/or the second substrate.

In an embodiment of the first and/or second aspect, the optical filter coating is a stack of a plurality of coating layers. The plurality of coating layers may be applied by laying several so called ‘material layers’ on top of each other. Each material layer is of a specific material and defines one so called coating layer (of the optical filter coating). Five of such material layers on top of each other thus provide a stack of five coating layers. The material layers/coating layers in one stack may be of different materials, but also one or more material layers of same material is conceivable in one stack. Such a material layer (=coating layer) can be built up by sputter depositing, for example, 20 molecular/atomic layers over each other in order to arrive at, according to this example, a said material layer of 20 molecular layers, in which the material layer/coating layer thus has a thickness of say about 20 molecules. When in this application the term layer is used in relation to an optical filter coating, the term layer is meant to be a material layer—in this application synonym for coating layer—and it is, unless said differently, not meant to be an atomic/molecular layer. A simple filter may have up to 20-30 (material/coating) layers, but more complex and complex filters may have about 70 or more (material/coating) layers. A simple filter may have 20-30 layers, but more complex and complex filters may have about 70 or more layers. The thickness of one coating layer may be in the range of 10 μm to 650 nm. The thickness of the optical filter coating, i.e. of the stack of coating layers, will depend on the number of coating layers and the thickness of each coating layer. The thickness of the stack—i.e. the thickness of the plurality of layers of the optical filter coatings—may be in the range of 50-400 nm. But when one of the single coating layer s already has a thickness of say 200 nm, the thickness of the stack my easily be larger than 400 nm.

In an embodiment of the first and/or second aspect, the step of forming a substrate stack comprises attaching, such as adhering, the second substrate onto the optical filter coating.

In an embodiment of the first and/or second aspect, the first substrate and the second substrate differ from each other in at least one of a thickness, a material and a density.

In an embodiment of the first and/or second aspect, the method comprises that, after the step of dicing, the diced parts of the second substrates are removed from the separated, individual portions.

In an embodiment of the first and/or second aspect, at least one of the first substrate and the second substrate is optical transparent for radiation in the range of 150-2500 nm, such as in the range of 200-1100 nm.

In an embodiment of the first and/or second aspect, the method further comprises the step of chamfering one or more outer edges of one or more of the plurality of individual portions. This step of chamfering may for example take place simultaneously or about simultaneously with the step of dicing, for example by having a circular rotating saw disc which additionally provided with a circular grinder provided on the sides of the saw blade and rotating together with the saw.

In an embodiment of the first and/or second aspect, the method further comprises the step of removing at least one of the separated, individual portions. This may for example include removing all separated, individual portions. But as follows from below further embodiments, this removing of separated, individual portions may also be limited to removing only one or more separated, individual portions—called ‘good portions’—which meet a predefined design criterium.

In an embodiment of the first and/or second aspect, the first substrate has a coating side facing to the optical filter coating—which may already have been applied or still is to be applied—and an opposing side facing away from the coating side; wherein the method further comprises the steps of:
adhering (109), before the step of dicing the substrate stack, the opposing side of the first substrate on a continuous carrier layer,
maintaining, during the step of dicing of the substrate stack, the continuity of the carrier layer,
removing at least one of the separated, individual portions from the carrier layer.
   With respect to the so called ‘coating side’ it is noted that this is the side where—after having been applied—the optical filter coating will be. With respect to this definition of this one side, that is noted that the coating may already be present at the moment of the step of ‘adhering’, but that it is also possible that the optical filter coating is applied after the step of ‘adhering’ or during the step of ‘adhering’.
   Further ‘maintaining the continuity of the carrier layer during the step of dicing the substrate stack’ means that the carrier layer is not diced through, bit that it may have—after the dicing step—a saw cut in its surface, which saw cut has a depth smaller than the thickness of the carrier layer.
   The carrier layer may for example be an adhesive foil.

In an embodiment of the first and/or second aspect, the method may further comprises the steps of:
determining whether
   one or more of the individual portions, or
   the optical filter coating of one or more of the individual portions meet a predefined design requirement associated to the specific spectral sensitivity;
labelling a said individual portions meeting the predefined design requirement as a ‘good portion’; and
removing one or more of the ‘good portions’ from the individual portions.
   The step of determining and the step of labelling may for example, take place after the dicing on the basis of determining measuring an optical characteristic of the individual portions and comparing the measured value with a predefined design criterium.

In an embodiment of the first and/or second aspect, the method may further comprises the steps of:
determining where the coated substrate meets a predefined design requirement associated to the specific spectral sensitivity;
labelling an area of the coated substrate as a ‘good area’ when the coated substrate meets the predefined optical design requirement in the respective area;
labelling the individual portions originating from a ‘good area’ as ‘good portions’; and
removing one or more of the ‘good portions’ from the individual portions.
   The step of determining and the step of labelling an area, may take place already before the dicing step. As the dicing will in general be according to a predefined pattern, the labelling of individual portions as ‘good portions’ can take place before, during, or after the step of dicing on the basis of information about the position of the substrate stack relative to the predefined pattern.

In an embodiment of the first and/or second aspect, the step of removing may comprise using a pick-and-place machine gripping the individual portion respectively ‘good portion’ to be removed. Pick-and-place machines are generally known and can be controlled by inputting a pick up location where the individual portion is to be picked up and a place location to where the individual portion picked up (gripped) by the machine is to be moved or displaced.

In an embodiment of the first and/or second aspect, the method further comprises a step of attaching the removed individual portion respectively removed ‘good portion’ to a filter frame. In case the individual portion attached to the filter frame is a so called good one, it has before attaching been assured that the attached individual portion meets the specs it is supposed to meet.

In a third aspect of the invention, there is provided a method for manufacturing an optical measurement device comprising one or more optical sensors—such as photodiodes and/or phototransistors—, and one or more individual portions obtained by a method according to the first and/or second aspect, wherein the method for manufacturing the optical measurement device comprises attaching and aligning the one or more optical sensors to the one or more individual portions such that radiation impinging on each of the optical sensors must have passed through a said filter aligned with the impinged sensor. The optical sensors—such as the photodiodes and/or phototransistors—may be sensitive for radiation in the range of 150-2500 nm, such as in the range of 200-1100 nm. The one or more sensors may, for example, be a plurality of at least 10 sensors or a plurality of 20 to 30 sensors or more. The plurality of sensors may for example comprise 64 sensors or more. In another example, the plurality of sensors may comprise 256 sensors or more.

In a fourth aspect of the invention, there is provided an optical filter system comprising a plurality of optical filters, each of the optical filters being formed by at least a part of a said individual portion obtained by a method according to the first and/or second aspect.

Each of the optical filters may for example be formed by one of:
a complete individual portion;
a diced part of the coated substrate portion, i.e. the diced part of the second substrate portion has been removed or at least is not (longer) part of the filter;
a diced part of the second substrate portion with the corresponding diced part of the optical filter coating, i.e. the diced part of the first substrate portion has been removed or at least is not (longer) part of the filter; and
a diced part of the optical filter coating, i.e. the diced parts of the first substrate portion and second substrate portion have been removed or at least are not (longer) part of the filter.
   The plurality of optical filters may also comprise a combination of one or more of the above listed four versions of optical filters.

In an embodiment of the fourth aspect, the optical filter system further comprises a filter frame, the plurality of optical filters being attached to the filter frame and arranged in an array. The array may be a 1-dimensional or a 2-dimensional array.

In an embodiment of the fourth aspect, each optical filter may have a specific spectral sensitivity different from the spectral sensitivities of the other optical filters.

In an embodiment of the fourth aspect, the specific spectral sensitivity may be configured for allowing passage of optical radiation at predefined wavelengths and preventing passage of optical radiation having wavelengths other than the predefined wavelengths. The predefined wavelengths may for example have bandwidth of 10 nm or less. This bandwidth may for example be 5 nm or less. It is foreseen that the bandwidth may be 2.5 nm or less or even smaller like in the range of 1 nm or less.

In an embodiment of the fourth aspect, the optical filter coating may have an optical filter property that is representative of a range of wavelengths that are transmittable through the first substrate and/or the second substrate.

In an embodiment of the fourth aspect, the optical filter coating is a stack of a plurality of coating layers. The plurality of coating layers may be applied by laying several so called ‘material layers’ on top of each other. Each material layer is of a specific material and defines one so called coating layer (of the optical filter coating). Five of such material layers on top of each other thus provide a stack of five coating layers. The material layers/coating layers in one stack may be of different materials, but also one or more material layers of same material is conceivable in one stack. Such a material layer (=coating layer) can be built up by sputter depositing, for example, 20 molecular/atomic layers over each other in order to arrive at, according to this example, a said material layer of 20 molecular layers, in which the material layer/coating layer thus has a thickness of say about 20 molecules. When in this application the term layer is used in relation to an optical filter coating, the term layer is meant to be a material layer—in this application synonym for coating layer—and it is, unless said differently, not meant to be an atomic/molecular layer. A simple filter may have up to 20-30 (material/coating) layers, but more complex and complex filters may have about 70 or more (material/coating) layers. A simple filter may have 20-30 layers, but more complex and complex filters may have about 70 or more layers. The thickness of one coating layer may be in the range of 10 μm to 650 nm. The thickness of the optical filter coating, i.e. of the stack of coating layers, will depend on the number of coating layers and the thickness of each coating layer. The thickness of the stack—i.e. the thickness of the plurality of layers of the optical filter coatings—may be in the range of 50-400 nm. But when one of the single coating layers already has a thickness of say 200 nm, the thickness of the stack my easily be larger than 400 nm.

In an embodiment of the fourth aspect, at least one of the first substrate and the second substrate is optical transparent for radiation in the range of 150-2500 nm, such as in the range of 200-1100 nm.

In a fifth aspect of the invention, there is provided an optical measurement device comprising an optical filter system according to the fourth aspect, and a plurality of optical sensors—such as photodiodes and/or phototransistors—, wherein the each said optical sensors is aligned with and attached to one of the optical filters of the optical filter system such that radiation impinging on each of the optical sensors must have passed through the filter aligned with the impinged sensor.

In an embodiment of the fifth aspect, the optical sensors may be photodiodes and/or phototransistors.

In an embodiment of the fifth aspect, the optical sensors may be sensitive for radiation in the range of 150-2500 nm, such as in the range of 200-1100 nm.

In an embodiment of the fifth aspect, the plurality of optical sensors may, for example, be a plurality of at least 10 sensors or a plurality of 20 to 30 sensors or more. The plurality of sensors may for example comprise 64 sensors or more. In another example, the plurality of sensors may comprise 256 sensors or more.

In an embodiment of the fifth aspect, the optical measurement device may comprise at least X optical filters and at least X optical sensors, X being 64 or more such as 256 or more. The number of optical filters may for example be the same as the number of optical sensors.

In an embodiment of the fifth aspect, the optical measurement device is a colorimeter.

In a sixth aspect of the invention, the optical measurement device according to the fifth aspect is used for measuring a color or colors of an object.

In an embodiment of the sixth aspect, the object has a display irradiating the color(s).

### BRIEF DESCRIPTION OF THE DRAWINGS

The invention will be described in more detail below under reference to the figures. In the figures exemplary embodiments of the invention are shown. The figures show in:

FIG. 1: a schematic representation of a method for manufacturing an optical filter according to the first aspect and second of the invention,

FIG. 2: schematically, a step of applying an optical filter coating on the first substrate, according to first and second aspect of the invention, FIG. 2A schematically showing an VPD process, and FIG. 2B schematically showing an optical filter coating,

FIG. 3: schematically, a step of providing a second substrate over the optical filter coating, according to the first and second aspect of the invention,

FIG. 4: schematically, a step of dicing the substrate stack into a plurality of separated, individual portions, according to the first and second aspect of the invention,

FIG. 5A: schematically, a detail of a separated, individual portion with a chipped outer edge,

FIG. 5B: schematically, a detail of a separated, individual portion with a chamfered outer edge,

FIG. 6: schematically, a step of dicing the substrate stack into a plurality of separated, individual portions, according to another embodiment of the first and second aspect of the invention,

FIG. 7: schematically, a step of removing the diced part of the second substrate from the individual portion, according to yet another embodiment of the first and second aspect of the invention,

FIG. 8: schematically, a step of use of an optical measurement device according to an embodiment of the fourth aspect of the invention for measuring a color of an object according to an embodiment of the sixth aspect of the invention.

FIG. 9 illustrates schematically the filter properties of the optical filter system according to an embodiment of the third aspect of the invention.

### DETAILED DESCRIPTION

To assist in clarifying the invention, a cartesian coordinate system is used. The cartesian coordinate system has an x-axis, a y-axis and a z-axis, which are all perpendicular to each other. The x-axis and the y-axis are in the horizontal plane. The z-axis is in the vertical direction. It is noted that the invention may be implemented with any orientation other than indicated in the figures.

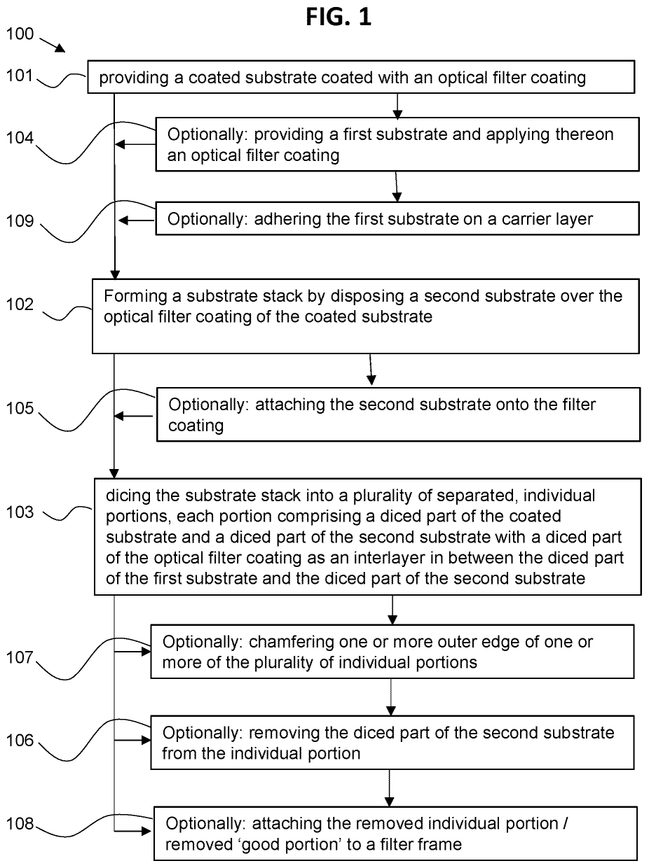

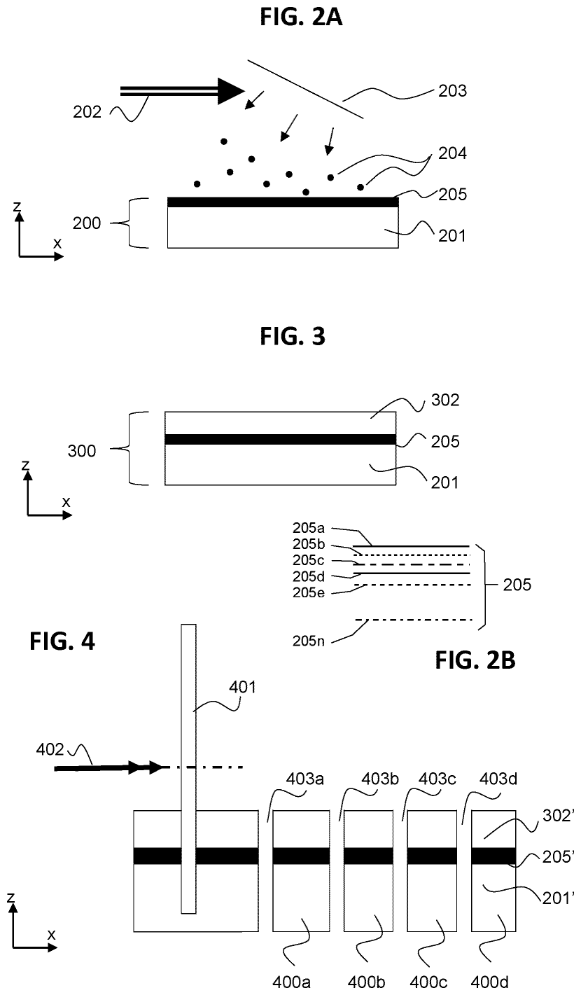

The invention relates to a method for dicing a substrate coated with an optical filter coating (fist aspect) as well as to a method for manufacturing an optical filter (second aspect). Both methods are schematically represented in FIG. 1 and indicated with the reference 100. Further details of the method 100 are also illustrated in FIGS. 2-9.

According to the first aspect, the method 100 comprises the steps of:
providing 101 a coated substrate 200 comprising a first substrate 201 coated with the optical filter coating 205 configured with a specific spectral sensitivity;
forming a substrate stack 300 by disposing 104 a second substrate 302 over the optical filter coating 205 of the coated substrate 200 such that the optical filter coating 205 forms an interlayer between the first substrate 201 and the second substrate 302;
dicing 105 the substrate stack 300 into a plurality of separated, individual portions 400a-400d, each portion 400a-400d comprising a diced part 200′ of the coated substrate 200 and a diced part 302′ of the second substrate 302 with a diced part 205′ of the optical filter coating 205 as an interlayer in between the diced part 201′ of the first substrate 201 and the diced part 302′ of the second substrate 302.
   According to the second aspect, the method 100 comprises the steps of:
providing 101 a coated substrate 200 comprising a first substrate 201 coated with an optical filter coating 205 configured with a specific spectral sensitivity;
forming a substrate stack 300 by disposing 104 a second substrate 302 over the optical filter coating 205 of the coated substrate 200 such that the optical filter coating 205 forms an interlayer between the first substrate 201 and the second substrate 302;
dicing 105 the substrate stack 300 into a plurality of separated, individual portions 400a-400d, each portion 400a-400d comprising a diced part 200′ of the coated substrate 200 and a diced part 302′ of the second substrate 302 with a diced part 205′ of the optical filter coating 205 as an interlayer in between the diced part 201′ of the first substrate 201 and the diced part 302′ of the second substrate 302, each portion providing basis for an optical filter.

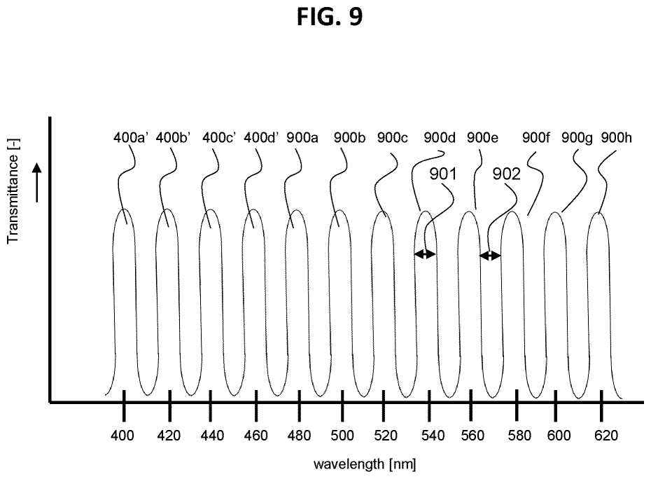

By applying the second substrate 302 over the optical filter coating 205 of the coated substrate 200, the second substrate 302 forms a protective layer for the optical filter coating 205. When dicing the substrate stack 300 into the plurality of individual portions 400a-400d, the outer edge of the diced part 302′ of the second substrate 302 may become damaged due to the forces that are applied during the dicing of the substrate stack 300. This damage may result in chipping of the outer edge of the individual portion 400a-400d. However, because the optical filter coating 205 is protected by the second substrate 302, no damage is caused to the optical filter coating 205. In use, see FIG. 8, this allows the optical filter coating 205 to properly filter optical radiation incident on the optical lens 400a′ directing the light incident to the optical filters 400b′, 400c′, and 400d′.

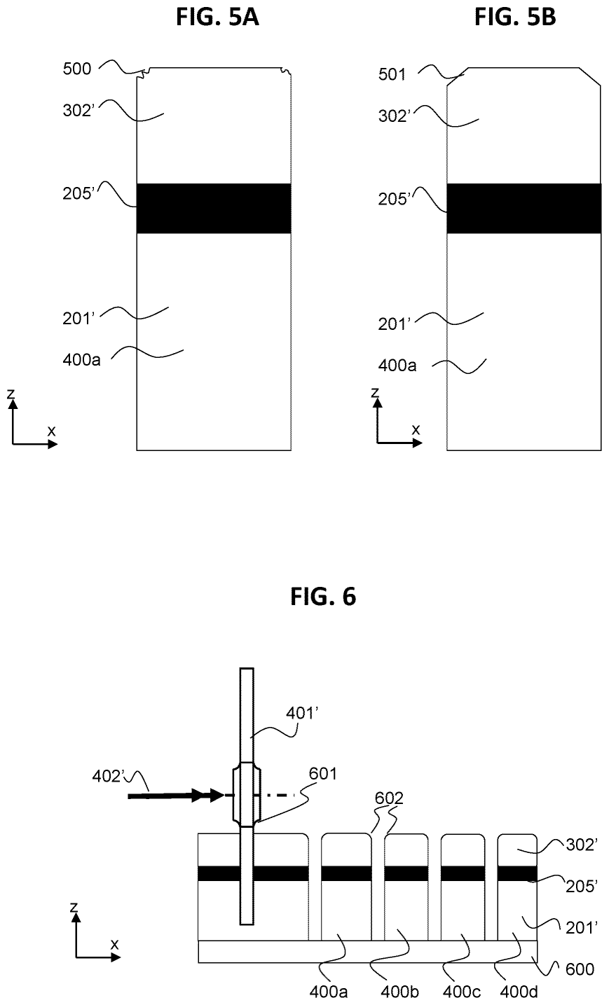

When the second substrate 302—see FIG. 3—does not provide, or hardly provides, filtering of the optical radiation propagating through the second substrate 302, the chipped outer edge 500—see FIG. 5A—of the diced parts 302′ of the second substrate 302 does not have a negative effect, or hardly any negative effect on the filtering property of the optical filter 400b′-400d′. As a result, the filtering property of the optical filter 400b′-400d′ is improved.

Although not illustrated in the drawings, the same applies for the first substrate 200. When the first substrate 200—see FIG. 3—does not provide, or hardly provides, filtering of the optical radiation propagating through the first substrate 201, a chipped outer edge—for example the outer edge on the right or left of the diced portion 201 in FIG. 5A—of the diced parts 201′ of the second substrate 302 does not have a negative effect, or hardly any negative effect on the filtering property of the optical filter 400b′-400d′. As a result, the filtering property of the optical filter 400b′-400d′ is improved.

The first substrate 201 is suitable for having the optical filter coating 205 applied thereon. The first substrate 201 is, for example, a wafer having a diameter of 20 nm or 30 nm or 100 mm or 150 mm or 200 mm or 300 mm. More in general, the diameter of the first substrate may be in the range of 20-30 mm to 300 mm. The first substrate 201 has, for example, a thickness of 0.5 mm or 0.7 mm or 1 mm or 2 mm, or more than 2 mm. The first substrate 201 is, for example, made from glass, but may be made from any material which is optical transparent within at least part of the range of 150-2500 nm. The first substrate 201 is, for example, transparent to the optical radiation that is allowed to pass through the optical filter coating 205. The first substrate 201 may, for example, also be not transparent to the optical radiation that is allowed to pass through the optical filter coating 205, in case the first substrate 201 is at least partly removed from the optical filter 400b′-400d′ to allow the optical radiation to pass through the optical filter 400b′-400d′.

The optical filter coating 205 allows passage of optical radiation at certain wavelengths, and prevents passage of optical radiation at other wavelengths. For example, the optical filter coating 205 allows passage of optical radiation at certain wavelengths, and absorbs optical radiation at wavelengths other than the certain wavelengths. For example, the optical filter coating 205 allows passage of optical radiation at certain wavelengths, and reflects or absorbs optical radiation at other wavelengths. By reflecting or absorbing the optical radiation at the other wavelengths, the optical radiation at the other wavelengths is not able to pass through the optical filter 400b′-400d′. The optical radiation allowed to pass is, for example, a part of the range of visible light (380-nm-780 nm), the optical radiation allowed to pass through the optical filter may for example be 500-525 nm. In other uses, the optical radiation allowed to pass through the optical filter may be a part of the range extending from 150 nm to 2250 nm.

The optical filter coating 205 is, for example, a thin-film optical filter coating 205. A thin-film optical filter coating 205 has a layer structure of various materials. The thickness of a thin film optical filter coating may, for example, be in the range of 50-400 nm. Depending on the materials and the thicknesses of the layers, the optical filter coating 205 allows passage of optical radiation at certain wavelengths, but prevents passage of optical radiation at other wavelengths. The material of the layers may comprise, for example, one or more of: magnesium fluoride, calcium fluoride, silicon-dioxide, other silicon-oxides, or metals like aluminum, silver, gold, tantalum, titanium, hafnium, other metals, and metal oxides like ditantalum-pentoxide, titanium-dioxide. The thickness and density of the thin layers cause, for example, destructive interference of light with certain wavelengths causing light with those wavelengths to be blocked, whereas light with other wavelengths is transmitted through the thin layers.

The optical filter coating 205 is applied to a surface of the first substrate 201, i.e., the main surface of the first substate 201, to form the coated substrate 200. The main surface may be completely covered with the optical filter coating 205. In another example, the main surface is partly covered with the optical filter coating 205. For example, part of the main surface near the edge of the main surface may not be covered with the optical filter coating 205.

The second substrate 302 is a substrate that is suitable for being provided over the optical filter coating 205 of the coated substrate 200. The second substrate 302 is, for example, a wafer having a diameter of of 20 nm or 30 nm or 100 mm or 150 mm or 200 mm or 300 mm. More in general, the diameter of the first substrate may be in the range of 20-30 mm to 300 mm. The second substrate 302 has, for example, a thickness of 0.5 mm or 0.7 mm or 1 mm or 2 mm, or more than 2 mm. The second substrate 302 is, for example, made from glass, The second substrate 201 is, for example, made from glass, but may be made from any material which is optical transparent within at least part of the range of 150-2500 nm. The second substrate 302 may, for example, be transparent to the optical radiation that is allowed to pass through the optical filter coating 205. The second substrate 302 may, for example, be not transparent to the optical radiation that is allowed to pass through the optical filter coating 205, in which case the second substrate 302 will at least partly removed from the optical filter 400b′-400d′ to allow the optical radiation to pass through the optical filter 400b′-400d′.

The first substrate 201 and the second substrate 302 may, for example, identical to each other. For example, the first substrate 201 and the second substrate 302 have the same size, the same thickness and/or are made from the same material. In an example, the first substrate 201 and the second substrate 302 are different from each other. In this example, the first substrate 201 and the second substrate 302 have at least one of a different size, a different thickness and/or are made from different materials.

The second substrate 302 is arranged such that the optical filter coating 205 is an intermediate layer between the first substrate 201 and the second substrate 302. As a result, one side of the optical filter coating 205 is covered by the first substrate 201, whereas the opposite side of the optical filter coating 205 is covered by the second substrate 302. The first substrate 201 and the second substrate 302 form a sandwich construction with the optical filter coating 205 as an interlayer in between the first substrate 201 and the second substrate 302. This sandwich construction is referred to as the substrate stack 300.

Dicing the substrate stack 300 into the plurality of individual portions 400a-400d is done, for example, by cutting or sawing or grinding. For example, dicing may be performed using a precision diamond dicing apparatus. In another example, the dicing may done by plasma cutting or laser cutting. When dicing the substrate stack 300 into the plurality of individual portion 400a-400d, cuts are made extending perpendicular to the main surface of the first substrate 201. By cutting this way, each of the individual portions 400a-400d has a diced part 201′ of the first substrate 201, a diced part 302′ of the second substrate 302 and a diced part 205′ of the optical filter coating 205.

After dicing the substrate stack 300 into the plurality of individual portions 400a-400d, one of the individual portions 400a may be selected as the optical filter 400b′-400d′. For example, the selected individual portion 400a undergoes further processing, such as polishing or additional coating. For example, measurements are done on the individual portions 400a-400d. In case a measurement indicates that a individual portion 400a meets a predefined design requirement, the individual portion 400a is called a ‘good individual portion’, and may be selected as the optical filter 400b′-400d′. In case the measurement indicates that a individual portion 400a does not meet the requirement, the individual portion 400a is not selected as the optical filter 400b′-400d′. The measurement includes, for example, measuring a parameter representative of the transmission of light through the individual portion 400a. The measurement includes, for example, measuring a spectrum of light transmitting through the individual portion 400a. The measurement includes, for example, examining the individual portion 400a—with a microscope. The predefined design requirement is, for example, representative of an optical filter property that is measured in case the optical filter coating 205 has been applied properly. In case the individual portion 400a meets the requirement, the individual portion 400a is able to perform the desired filtering of the optical radiation.

In an embodiment, the method 100 may comprises a step 107 of chamfering an outer edge 501 of one or more of the plurality of individual portions 400a. This chamfering may take place after the dicing, but may also be done simultaneously with the dicing. In case the dicing tool is a saw, the saw may be provided with a grinder for simultaneously chamfering by grinding.

This way, sharp edges may be removed to allow safe handling of the optical filter 400b′-400d′. In addition, in case the outer edge has a chipped area, the chamfering removes the chipped area. By removing the chipped area, the risk of the optical filter 400b′-400d′ releasing particles is reduced. The size of the chamfer may be selected as desired. The chamfer is, for example, large enough to provide an outer edge that is not sharp. For example, the chamfer is large enough to extend over the chipped area near the outer edge. The chamfer is small enough not to extend through the optical filter coating 205. Extending the chamfer through the optical filter coating 205 may locally remove part of the optical filter coating 205. This would negatively affect the functionality of the optical filter 400b′-400d′, because optical radiation could pass through the optical filter 400b′-400d′ without passing through the optical filter coating 205. In case a large chamfer is desired, the thickness of the second substrate 302 is, for example, selected to be sufficiently large. The large thickness of the second substrate 302 allows a large chamfer without the chamfer reaching the optical filter coating 205.

In an embodiment, step 102 of forming a substrate stack by disposing the second substrate 302 over the optical filter coating 205 on the coated substrate 200 may comprises a step of attaching 105, for example by adhering, the second substrate 302 onto the optical filter coating 205.

According to this embodiment, by guiding the second substrate 302 onto the optical filter coating 205, the substrate stack 300 is formed as a solid object. This allows accurate handling of the substrate stack 300, resulting in that the step 103 of dicing the substrate stack 300 into the plurality of individual portions 400a-400d can be done accurately. For example, the adhesive is an optical adhesive that allows optical radiation to pass through. In the example that the second substrate 302 is to be removed, this can be done by simply dissolving the adhesive and/or by heat treatment of the individual portions 400a-400d. Due to the heat treatment, the adhesive becomes weak allowing the diced part 302′ of the second substrate 302 to be removed from the individual portions 400a-400d.

In an embodiment, the first substrate 201 and the second substrate 302 differ from each other in at least one of a thickness, a material and a density.

In an embodiment, the method 100 comprises after the step 103 of dicing the substrate stack 300 into a plurality of individual portions 400a-400d, a step 106 of removing the diced part 302′ of the second substrate 302 from the individual portion 400a.

In this embodiment, the second substrate 302 has a function of protecting the optical filter coating 205 during step 103 of dicing the substrate stack 300 into the plurality of individual portions 400a-400d. However, the second substrate 302 does not have a function in the finished end product of the optical filter 400b′-400d′. Removing the second substrate 302 from the individual portion 400a, allows the second substrate 302 to have properties that would interfere with the function of the optical filter 400b′-400d′. For example, the second substrate 302 is not transparent to optical radiation. For example, the second substrate 302 is made from a material that allows for easy cutting. For example, the second substrate 302 is made from a ductile material to reduce the number of particles created during the step 103 of dicing the substrate stack 300. The ductile material is less brittle than the material of which the first substrate 201 is made, such as glass. For example, the second substrate 302 is provided with markers to help guide the tool that divides the substrate stack 300.

In an embodiment, the method 100 may comprise an additional step 109. Step 109 is adhering, before step 103 of dicing the substrate stack 300, the first substrate 201 on a carrier layer 600. During step 103 of dicing the substrate stack 300, while maintaining the carrier layer 600 as undivided. Another additional step is removing the one of the plurality of individual portions 400a from the carrier layer 600.

According to this embodiment, the carrier layer 600 supports the substrate stack 300 via the first substrate 201. When the substrate stack 300 is divided into the plurality of individual portions 400a-400d, the carrier layer 600 is not divided. As a result, the plurality of individual portions 400a-400d are still connected to each other via the carrier layer 600. This allows for easily handling of the individual portions 400a-400d, because they handle as a single object instead of multiple objects that are moveable relative to each other. For example, during step 103 of dicing of the substrate stack 300 into the plurality of individual portions 400a-400d, the carrier layer 600 is partly cut. For example, the carrier layer 600 may be a flexible foil. For example, the carrier layer 600 may be the same type of substrate as the first substrate 201 or the second substrate 302.

In an embodiment, the step of removing the one of the plurality of individual portions 400a from the carrier layer 600 comprises using a pick-and-place machine to grip the individual portion 400a and to separate the individual portion 400a from the carrier layer 600.

According to this embodiment, a pick-and-place machine is used. A pick-and-place machine is a commercially available machine that is able to pick up small objects and to place the small objects at a desired location. By keeping the individual portions 400a-400d connected to each other via the carrier layer 600, the locations of the individual portions 400a-400d are well defined. This allows the pick-and-place machine to easily grip an individual portion 400a-400d and to place it on a desired location. The desired location is, for example, a filter frame 803 of an optical filter system 802, wherein the filter frame 803 supports the optical filter 400b′-400d′. The pick-and place machine is able to remove the individual portion 400a from the carrier layer 600 and/or to divide the carrier layer 600 to pick up the individual portion 400a. For example, the pick-and-place machine locally breaks or tears the carrier layer 600 while picking up an individual portion 400a-400d.

In an embodiment, step 109 of providing the first substrate 201 on the carrier layer 600 comprises adhering the first substrate 201 to the carrier layer 600.

By adhering the first substrate 201 to the carrier layer 600, there is a proper connection between the first substrate 201 and the carrier layer 600. This way, the individual portions 400a-400d are well connected to each other via the carrier layer 600, and thus are the locations of the individual portions 400a-400d well defined on the carrier layer 600. However, the adhesive allows the individual portions 400a-400d to be released from the carrier layer 600 when the pick-and-place machine picks up the individual portions 400a-400d. For example, the pick-and place machine pulls the individual portion 400a with a force that exceeds the adhesive force of the adhesive. For example, the pick-and-place machine locally heats the adhesive at the individual portion 400a to weaken the adhesive. For example, the pick-and-place machine grips the individual portion 400a and performs a rotational movement and/or a tilt movement of the individual portion 400a to break the adhesive. For example, the adhesive is applied with a single dot at the center of each individual portion 400a-400d. When the pick-and-place machine rotates the individual portion 400a along an axis through the corresponding adhesive dot and perpendicular to the main surface of the first substrate 201, the adhesive dot can be broken with only a small force.

In an embodiment, at least one of the first substrate 201 and the second substrate 302 comprises glass.

In an embodiment, the method 100 comprises step 108 of attaching the one of the plurality of individual portions 400a-400d to a frame 803.

In a fourth aspect of the invention, there is provided an optical filter system 802 comprising a frame 803, and the optical filter 400b′-400d′ manufactured according to the first and/or second aspect of the invention, wherein the frame 803 supports the optical filter 400b′-400d′.

In an embodiment, the optical filter system 802 comprises at least one additional optical filter 400b′-400d′. The at least one additional optical filter 400b′-400d′ is manufactured according to the method according to the first and/or second aspect of the invention. The additional optical filter 400b′ is formed by individual portion 400b. The additional optical filter 400c′ is formed by individual portion 400c. The additional optical filter 400d′ is formed by individual portion 400d. The least one additional optical filter 400b′-400d′ is attached to the frame 803.

According to this embodiment, the optical filter 400b′-400d′ comprises multiple optical filters 400b′-400d′ that each has an optical filter coating 205 that is unaffected by chipped edges. The process of applying the optical filter coating 205 is a delicate process. The optical filter coating 205 is, despite great care, typically not applied correctly across the entire main surface of the first substrate 201. The surface area on which the optical filter coating 205 is applied properly, may be as low as 50% or less. By providing the optical filter system 802 with additional optical filter 400b′-400d′ which are not affected by chipped edges, it is prevented that individual portions 400b-400d that have a properly applied optical filter coating 205 portion are discarded. In addition, this allows the construction of a large optical filter without the need to have the optical filter coating 205 applied correctly to a large continuous surface of the first substrate 201. This increases the yield when producing the individual portions 400a-400d.

In an embodiment, the optical filter 400b′-400d′ is configured to allow passage of a first range of optical radiation and to block optical radiation outside the first range. The at least one additional optical filter 400b′ is configured to allow passage of a second range of optical radiation and to block optical radiation outside the second range. The first range may be different from the second range.

In this embodiment, the optical filter 400b′-400d′ allows passage of a first range of optical radiation, for example red light. The additional optical filter 400b′ allows passages of a second range of optical radiation, for example green light. This allows the optical filter system 802 to separate different colors. For example, the optical filter system 802 separates different colors to lead each color to a dedicated sensor. In an example, the first range is completely separate from the second range, such as in the example that the first range are wavelengths less than 400 nm, whereas the second range are wavelengths higher than 500 nm. In another example, there is overlap between the first range and the second range. For example, the first range are wavelengths of 400-700 nm, whereas the second range has wavelengths of 450-700 nm. For example, the first range has a different cut off frequency than the second range.

In an embodiment, the optical filter system 802 comprises a plurality of additional optical filter 400b′-400d′, wherein each additional optical filter 400b′-400d′ has a range different from each other and from the first range.

According to this embodiment, the additional optical filter 400b′-400d′ each have different ranges, and the first range of the optical filter 400b′-400d′ is different from the ranges of the additional optical filter 400b′-400d′. Because of these different ranges, the optical filter system 802 is able to filter the optical radiation that includes a large range of wavelengths. For example, all optical filters 400b′-400d′ together expand a range between ultraviolet and near infrared. For example, all optical filters 400b′-400d′ together expand a range of 380 nm-780 nm. Because each optical filter 400b′-400d′ has its own range, the optical filter system 802 is able to accurately separate the different wavelengths. It is however to be noted, that not all optical filters 400b′-400d′ have to be different by definition. It may be useful to provide each optical filter 400b′-400d′ in duplicate or triplicate to allow for redundancy or to serve as a reserve in case an optical might fail to function properly.

In an embodiment, the optical filter 400b′-400d′ and the plurality of additional optical filters 400b′-400d′ are arranged in an array.

By arranging the filters in an array—like a matrix pattern—, the optical radiation can be directed to the optical filters 400b′-400d′ using relatively simple optics, such as mirrors, lenses and diffusors. For example, having 64 optical filters 400b′-400d′ allows for a convenient arrangement of the optical filters 400b′-400d′ on the frame 803 in an 8×8 matrix. For example, having 256 optical filters 400b′-400d′ allows for a convenient arrangement of the filters on the frame 803 in a 16×16 matrix.

In a fifth aspect of the invention, there is provided an optical measurement device 800 comprising an optical filter system 802 according to the fourth aspect of the invention, and a plurality of optical sensors 811a-d. The optical filter 400b′-400d′ and the plurality of additional optical filters 400b′-d′ each are paired with one of the plurality of optical sensors 811a-d to propagate filtered optical radiation to the paired one of the plurality of optical sensors 811a-d.

According to the fifth aspect, each of the optical sensors 811a-d is paired with one of the optical filters 400b′-400d′ in the optical filter system 802. Each optical sensor 811a-d is aligned with the corresponding optical filter 400b′-400d′-400d′ to receive the optical radiation in the range of wavelengths that passes the corresponding filter. For example, the optical sensors 811a-d are photodiodes.

Each optical sensor 811a-d generates a sensor signal based on the intensity of optical radiation that is incident on the optical sensor 811a-d. Based on the color or colors of the optical radiation incident on the optical measurement device 800, some optical filters 400b′-400d′ allow optical radiation to pass with a high intensity, whereas other optical filters 400b′-400d′ allow optical radiation to pass only with a low intensity, or do not allow any optical radiation to pass. As a result, some optical sensors 811a-d generate a sensor signal representative of a high intensity, whereas other optical sensors 811a-d generate a sensor signal representative of a low intensity. These different intensities give an accurate representation of the wavelengths in the optical radiation as measured by the optical measurement device 800.

In an embodiment, the optical measurement device 800 comprises at least 64 optical filters 400b′-d′ and 64 optical sensors 811a-d, for example, at least 256 optical filters 400b′-d′ and 256 optical sensors 811a-d.

Because the number 64 is a power of 2, the 64 signals from the 64 optical sensors 811a-d can be processed efficiently, for example by using Fast Fourier Analysis. When providing each optical filter 400b′-400d′ with a range that is different from the other optical filters 400b′-400d′, and dividing the ranges over the spectrum of visible light (380 nm-780 nm), the optical measurement device 800 is able to obtain a resolution of 6.25 nm. This resolution equals the resolution of an expensive high-end spectrometer. For example, each of the 64 optical filters 400b′-400d′ is paired with an optical sensor 811a-d. Each of the 64 sensor signals is representative of an intensity of the wavelengths in the range of the corresponding optical filter 400b′-400d′.

According to an example of this embodiment, the optical filter system 802 has 256 optical filters 400b′-400d′, i.e., the optical filter 400b′-400d′ and 255 additional optical filters. When providing each optical filter 400b′-400d′ with a range that is different from the other optical filters 400b′-400d′, and dividing the ranges over the spectrum of visible light (380 nm-780 nm), the optical measurement device 800 is able to obtain a resolution of 1.56 nm. This resolution is better than the typical resolution of an expensive high-end spectrometer. Because the number 256 is a power of 2, the processing unit is able to efficiently process the sensor signals, for example by using Fast Fourier Analysis.

In an embodiment, the optical measurement device 800 comprises a sensor frame 803, wherein the plurality of optical sensors 811a-d are attached to the sensor frame 803. The optical sensors 811a-d are arranged on the sensor frame 803 in a sensor array 812. The optical filter 400b′-400d′ and the plurality of additional optical filters 400b′-d′ are arranged in a filter array 814. The filter array 814 and sensor array 812 have a same pattern and are aligned such that the optical filters 400b′-400d′ and optical sensors 811a-d form pairs. The optical sensor 811a-d of each pair being aligned with the optical filter 400b′-400d′ of that pair.

In an embodiment, the optical measurement device 800 is a colorimeter.

A colorimeter is an optical measurement device 800 that is configured to measure color. The colorimeter generates an output signal via the output terminal 805 that represents the measured color. The output signal represents the measured color in chromaticity coordinates in red, green and blue. These chromaticity coordinates are typically referred to as tristimulus values X (red), Y (green) and Z (blue). By creating the optical filter 400b′-400d′ and optionally the additional optical filters 400b′-d′, according to the invention, an accurate optical filter system 802 for the colorimeter is obtained. As a result, the colorimeter is able to perform high accuracy color measurements. Each of the optical filters 400b′-400d′ is, for example, created to be passable by wavelengths in a desired range and at a desired transmittance. This way, the optical filter system 802 is optimized to take into account any filtering caused by other optical components in the colorimeter. This improves the accuracy of the colorimeter.

In an embodiment, the optical measurement device 800 is adapted to irradiate the optical filter 400b′-400d′ with a beam of optical radiation 823 having a beam width extending a width of the optical filter 400b′-400d′.

According to this embodiment, the optical measurement device 800 is adapted to receive optical radiation and to propagate the optical radiation as a beam to the optical filter 400b′-400d′. The optical measurement device 800 has optical components, such as a diffusor, to create a wide beam of radiation towards the optical filter 400b′-400d′. This ensures that the optical radiation is incident on the optical filter 400b′-400d′. In case the optical measurement device 800 comprises the additional optical filters 400b′-d′, the beam 823 is wide enough to irradiate the optical filter 400b′-400d′ and the additional optical filters 400b′-d′. As a result of the wide beam, the edge of the optical filter 400b′-400d′ receives optical radiation. Because the optical filter coating 205 was not damaged while dicing the substrate stack 300 into the plurality of individual portions 400a-400d, the optical filter coating 205 is able to properly filter the optical radiation of beam 823 incident near the edge of the optical filter 400b′-400d′. As a result, the optical measurement device 800 is able to measure the optical radiation more accurately.

In a sixth aspect of the invention, the invention relates to use of the optical measurement device 800 according to the fifth aspect of the invention for measuring a color of an object 820.

In an embodiment, the object has a display 821 irradiating the color.

Displays of various devices, for example, mobile devices such as mobile phones and tablets, or monitors, such as tv monitors or computer monitors, display color when in use. In the production process of such a display, it is typical desired to measure the colors that the display irradiates to ensure that the irradiated colors match with a set of desired colors. For example, it is desired that all mobile phones of a certain type display the color blue in the same way, i.e., by irradiating the same wavelength or same wavelengths. By using the optical measurement device 800 according to the embodiments above, the optical measurement device 800 is able to accurately measure the colors irradiated by the display 820. The optical measurement device 800 gives an output signal representative of the measured color. The output signal is, for example, compared with a reference signal that is representative of the desired color. In case the output signal deviates from the reference signal, for example, the display of the device is adjusted. The output signal is, for example, representative of tristimulus values X (red), Y (green) and Z (blue).

FIG. 2 illustrates, in an embodiment, step 104 of applying the optical filter coating 205 on the first substrate 201 according to the first and/or second aspect of the invention. The first substrate 201 is placed in a physical vapor deposition (PVD) apparatus, in this example an ion beam sputtering (IBS) apparatus, see FIG. 2A. The ion beam sputtering apparatus directs an ion beam 202 onto a target 203. Due to the energy provided by the ion beam 202, a physical reaction in the target occurs, causing the target to release atoms/molecules 204 of a specific material. When the atoms/molecules 204 reach the first substrate 201, the atoms 204 form a thin atomic/molecular layer of material. After having finished one atomic molecular layer, this process is repeated to until the number of atomic/molecular layers results in see FIG. 2B—a coating layer 205a (of the specific material) having a desired layer thickness. Subsequently, this PVD process may be repeated an (n−1)-number of times to create more such coating layers 205b, 205c, 205d, 205e, . . . , 205n until a stack of a plurality of n desired coating layers is obtained. All these n coating layers may be different from one another, but frequently one or more type of layers will be present in a stack several times, like layers 205a and 205d in the example of FIG. 2B. The stack of coating layers 205a, 205b, 205c, 205d, 205e, . . . 205n forms the optical filter coating 205. The combination of the first substrate 201 with the optical filter coating 205 on the main surface of the first substrate 201 forms the coated surface 200.

FIG. 3 illustrates, in an embodiment, step 102 of forming a substrate stack by disposing the second substrate 302 over the optical filter coating 205 of the coated substrate 200 with the optical filter coating 205 between the first substrate 201 and the second substrate 302. The first substrate 201 and the second substrate 302 form a sandwich construction with the optical filter coating 205 in between the first substrate 201 and the second substrate 302. This sandwich construction is referred to as the substrate stack 300.

FIG. 4 illustrates, in an embodiment, step 103 of dicing the substrate stack 300 into a plurality of individual portions 400a-400d, wherein each individual portion 400a-400d has a diced part 201′ of the first substrate 201, a diced part 302′ of the second substrate 302 and a diced part 205′ of the optical filter coating 205.

A dicing blade 401 is provided, which is formed as a cutting wheel that is rotatable about axis 402. While the dicing blade 401 is rotating, the dicing blade 401 is moved downward in the z-direction to sequentially create the cuts 403a-403d in the substrate stack 300. After every cut, the dicing blade 401 is moved upward in the z-direction to be clear of the substrate stack 300. The dicing blade 401 is then moved along the x-axis to the left of the figure to start with the next cut.

The cuts 403a-403d extend in the z-direction, which is perpendicular to the main surface of the first substrate 201. The main surface of the first substrate 201 is in the xy-plane. As a result, the cuts 403a-403d form the individual portions 400a-400d. Each of the individual portions 400a-400d has a diced part 201′ of the first substrate 201, a diced part 302′ of the second substrate 302 and a diced part 205′ of the optical filter coating 205. Note that the diced part 201′ of the first substrate 201, the diced part 302′ of the second substrate 302 and the diced part 205′ of the optical filter coating 205 are only indicated with reference signs at individual portion 400d for clarity reasons.

FIG. 5A illustrates a detail of the individual portion 400a. Due to step 103 of dicing the substrate stack 300 with the dicing blade 401, the individual portion 400a has a chipped outer edge 500. Because of the thickness of the diced part 302′ of the second substrate 302, the chipped outer edge 500 is only present on the diced part 302′ of the second substrate 302, but does not extend to diced part 205′ of the optical filter coating 205. As a result, the chipping did not result in any damage to the optical filter coating 205.

FIG. 5B illustrates a detail of the individual portion 400a in an embodiment of the invention. In this embodiment, the individual portion 400a has been provided with a chamfered outer edge 501. A grinding or polishing step has been taken to provide the chamfered outer edge 501. The chamfer of the chamfered outer edge 501 is selected to be sufficiently large to remove all chipped areas of the chipped outer edge 500. As is visible in the figure, the chamfer only extends across the diced part 302′ of the second substrate 302, but not across the diced part 205′ of the optical filter coating portion 205. As a result, the diced part 205′ of the optical filter coating 205 was unaffected by the chamfering step 107. As shown in the figure, the chamfer may even extend more in the negative z-direction, as long as the chamfer does not reach the diced part 205′ of the optical filter coating 205.

FIG. 6 illustrates step 103 of dicing the substrate stack 300 into a plurality of individual portions 400a-400d, according to an embodiment of the first and/or aspect of the invention. The embodiment of FIG. 6 is the same as the embodiment illustrated in FIG. 4, except for the following.

To divide the substrate stack 300 into the plurality of individual portions 400a-400d, a dicing blade 401′ is provided with a concave grindstone 601. When the dicing blade 401′ rotates along axis 402′ and moves in the negative z-direction, the outer edge of the dicing blade 401′ creates the cuts between the individual portions 400a-400d. In addition, when the dicing blade 401′ is near its lowest position in the z-direction, the concave grindstone 601 contacts the top edges of the individual portions 400a-400ds. Due to the concave shape of the concave grindstone 601, the concave grindstone 601 creates a rounded chamfer 602 at the top edges of the individual portions 400a-400ds. This way, providing the chamfer and dicing the substrate stack 300 into the individual portions 400a-400d is done in a single production step.

In addition, FIG. 6 illustrates the carrier layer 600. Before step 103 of dicing the substrate stack 300, the first substrate 201 was placed on the carrier layer 600. For example, the first substrate 201 and the carrier layer 600 are adhered to each other. During step 103 of dicing the substrate stack 300, the carrier layer 600 is maintained as undivided. The dicing blade 401′ did not move to a low enough z-position which would cause the dicing blade 401′ to cut the carrier layer 600 into portions. In a following step, the plurality of individual portions 400a-400d are removed from the carrier layer 600. For example, the plurality of individual portions 400a-400d are removed from the carrier layer 600 using a pick-and-place machine to grip the individual portions 400a-400d and to separate the individual portions 400a-400d from the carrier layer 600.

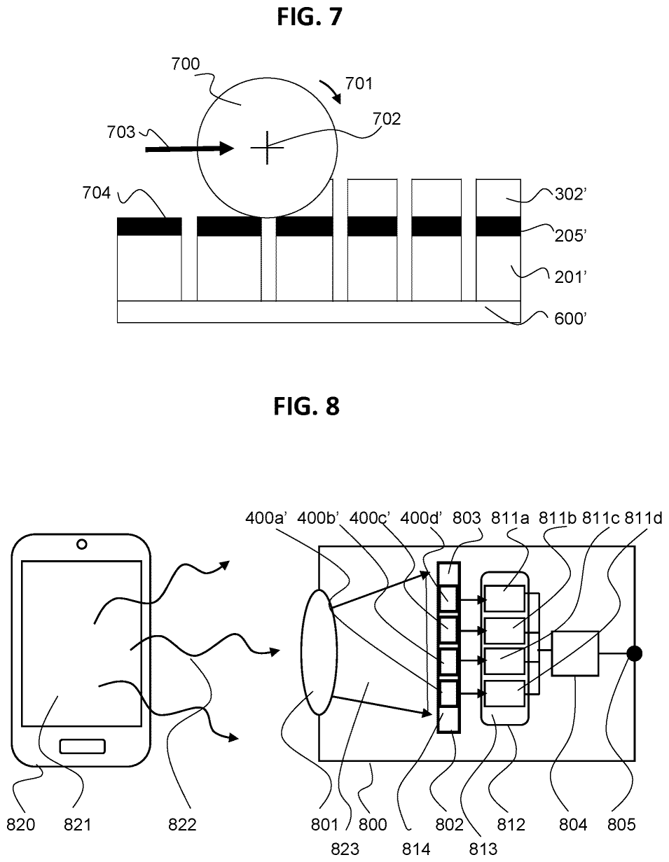

FIG. 7 illustrates step 106 of removing the diced part 302′ of the second substrate 302 from the individual portion 400a, according to an embodiment of the first and/or second aspect of the invention. The embodiment of FIG. 7 is, for example, the same as the embodiment of FIG. 6 except for the following.

After the dicing blade 401 has divided the substrate stack 300 into the individual portions 400a-400d, a griding wheel 700 is provided. The grinding wheel 700 is rotatable in the direction 701 about axis 702, which is parallel to the y-axis. The grinding wheel 700 moves along the translational direction 702 in the x-direction across the substrate stack 300. The depth of the grinding wheel 700 in the z-direction is set to have the grinding wheel 700 grind the diced part 302′ of the second substrate 302 from the individual portions 400a-400d. After the grinding wheel 700 has completed this step, a top surface 704 of the diced parts 205′ of the optical filter coating 205 is no longer covered by the diced parts 302′ of the second substrate portions 302.

FIG. 8 illustrates an optical measurement device 800 according to the fifth aspect of the invention. The optical measurement device 800 has an optical filter system 802 according to the fourth aspect of the invention. The optical measurement device 800 is used according to a fourth sixth of the invention. The optical measurement device 800 is a colorimeter.

The optical filter system 802 a plurality of optical filters 400b′-400d′ and a frame 803 supporting the optical filters 400b′-400d′. The optical filters 400b′-400d′ are manufactured according to the first and/or second aspect of the invention.

The optical filter system 802 is formed by performing step 108 of attaching a plurality of individual portions 400a-400d to the filter frame 803. Individual portion 400a forms one of the optical filters 400b′-400d′, whereas individual portions 400b-400d form additional optical filters 400b′-d′.

The optical filter 400b′-400d′ formed by individual portion 400a is configured to allow passage of a first range of optical radiation and to block optical radiation outside the first range. The optical filter 400b′ formed by individual portion 400b is configured to allow passage of a second range of optical radiation and to block optical radiation outside the second range, wherein the first range is different from the second range. Further, the additional optical filters 400c′-d′ formed by respectively individual portion 400c and 400d each has a range different from each other and from the first range. As a result, each of the optical filters 400b′-400d′ allows passage of a range of optical radiation different from the other optical filter 400b′-400d′.

The optical filters 400b′-400d′ formed by the individual portions 400a-400ds are arranged in a sensor array 812. In this embodiment, the sensor array 812 is a 1D-array having a single row of four optical filters 400b′-400d′. Alternatively, the sensor array 812 is a 2D-array having two rows with each row having two optical filter 400b′-400d′.

The optical measurement device 800 comprises a window 801 to receive a light beam of optical radiation 822 from an object 820. In this embodiment, the object 820 is a mobile device having a display 821. The display 821 irradiates visible light with multiple colors. The display 821 irradiates the visible light as light beams 822 and some of these light beams are incident on the window 801. The window 801 allows the light beam 822 to enter the optical measurement device 800.

The optical measurement device 800 further comprises the optical filter system 802 according to the fourth aspect of the invention. In addition, the optical measurement device 800 comprises a plurality of optical sensors 811a-d. The optical filters 400b′-400d′ each are paired with one of the plurality of optical sensors 811a-d to propagate filtered optical radiation to the paired one of the plurality of optical sensors 811a-d. The optical sensors 811a-d are arranged in a sensor array 812 on a sensor frame 803. The sensor array 812 corresponds to the array of the optical filters 400b′-400d′ to pair each optical filter 400b′-400d′ with each optical sensor. The optical measurement device 800 further comprises a processing unit and an output terminal 805.

The window 801 receives the light beam of optical radiation 822 from the object 820 and divides the light beam as light beam of optical radiation 823 over the array of optical filters 400b′-400d′ in the optical filter system 802. The window 801 is adapted to divide light beam 822 to irradiate the optical filter 400b′-400d′ with light beam of optical radiation 823 having a beam width extending a width of the optical filter 400b′-400d′. The plurality of optical filters 400b′-400d′ include the optical filters 400b′-400d′ formed by the individual portions 400a-400d. Optionally, the optical measurement device 800 comprises additional optical components arranged between the window 801 and the optical filter system 802 to divide the light beam 823 over the optical filter system 802.

Depending on the filter properties of each optical filter 400b′-400d′, each optical filter 400b′-400d′ allows passage of optical radiation in a range of wavelengths.

The sensor array 812 comprises a plurality of optical sensors 811a-d. In this embodiment, the optical sensors 811a-d are photodiodes. Each of the optical sensors 811a-d is paired with one of the optical filters 400b′-400d′ in the optical filter system 802. Each optical sensor 811a-d is aligned with the corresponding optical filter 400b′-400d′ to receive the optical radiation in the range of wavelengths that passes the corresponding filter.

Each optical sensor 811a-d generates a sensor signal in based on the intensity of optical radiation that is incident on the optical sensor 811a-d. Based on the color or colors irradiated by the display 821, some optical filters 811a-d allow optical radiation to pass with a high intensity, whereas other optical filters 811a-d allow optical radiation to pass only with a low intensity, or do not allow any optical radiation to pass. As a result, some optical sensors 811a-d generate a sensor signal representative of a high intensity, whereas other optical sensors 811a-d generate a sensor signal representative of a low intensity. The sensor signals are transmitted to the processing unit 804. The processing unit 804 processes the sensor signals to generate an output signal representative of the color or colors of the display 821. The processing unit 804 sends the output signal to the output terminal 805. For example, the output terminal 805 is connectable to a device, such as a display, to indicate the measured color to the person operating the optical measurement device 800.

Although not shown in the figure, optionally, the optical measurement device 800 comprises at least 64 optical filter in the optical filter system 802, and at least 64 optical sensors. For example, the optical measurement device 800 comprises at least 256 optical filter and 256 optical sensors.

The optical measurement device 800 comprises a sensor frame 803. The plurality of optical sensors 811a-d are attached to the sensor frame 803. The optical sensors 811a-d are arranged on the sensor frame 803 in a sensor array 812. The optical filter 400b′-400d′ and the plurality of additional optical filters 400b′-d′ are arranged in a filter array 814. The filter array 814 and sensor array 812 have a same pattern and are aligned such that the optical filters 400b′-400d′ and optical sensors 811a-d form pairs, the optical sensor 811a-d of each pair being aligned with the optical filter 400b′-400d′ of that pair.

The optical measurement device 800 is used for measuring a color of the object 820. The object 820 is the display 821 irradiating the color via the light beam of optical radiation 822.

FIG. 9 illustrates, in a graph, filter properties of the optical filter system 802 according to an embodiment of the fourth aspect of the invention.

Each optical filter 400b′-400d′ in the optical filter system 802 has relationship between the amount of optical radiation an optical filter allows to pass as a function of the wavelength. For some wavelengths, an optical filter has a high transmittance, which means that a large amount or all of the optical radiation with these wavelengths pass through the optical filter. For other wavelengths, the optical filter has a low transmittance, which means that only a small amount or no optical radiation with these wavelengths pass through the optical filter.

The graph shows the filter properties of optical filters 400b′-400d′. In addition, the graph shows the filter properties of additional optical filters 900a-h. The optical filter system 802 comprises the optical filters 400b′-400d′ and the additional optical filters 900a-h.

Each optical filter 400b′-400d′ allows passage of a range of optical radiation different from the other optical filters 400b′-400d′. Each range has a width 901, which is about 20 nm in the graph. Because each optical filter has a different range, all optical filters together cover a large portion of the visible light spectrum at a high resolution. Note that there is a gap 902 between the ranges 901. Because of the gap 902, the optical measurement device 800 is not sensitive to wavelengths that are in the gap 902, such as the wavelength of 570 nm. Depending on the application of the optical measurement device 800, it may be acceptable that the optical measurement device 800 is not sensitive to some wavelengths. Alternatively, the range 901 may be broadened such that the gap 902 is reduced to zero or almost zero. For example, a range overlaps with the two adjacent ranges.

By increasing the number of optical filters, or by limiting the measurement range of the optical measurement device 800, the range 901 is, for example 5 nm or less.

As shown in FIG. 9, optical filter 400b′-400d′ allows wavelengths between 390-410 nm to pass, but blocks all other wavelengths. Additional optical filter 400b′ allows wavelengths between 410-430 nm to pass, but blocks all other wavelengths. Additional optical filter 400c′ allows wavelength between 450-470 nm to pass, but blocks all other wavelengths. Additional optical filter 400c′ allows wavelength between 470-490 nm to pass, but blocks all other wavelengths.

In an embodiment, multiple optical filters are attached to the frame 803 that have the same range. For example, three additional filters 400d′ are attached to the frame 803. This makes the optical measurement device 800 more sensitive to wavelengths in the range of 450-470 nm.

Embodiments and further embodiments of the present invention—which (further) embodiments may be broader than claimed in the claims—may be expressed in words as set out in the following clauses:

Clause 1] Method (100) for dicing a substrate coated with an optical filter coating (205), the method (100) comprising the steps of:
providing (101) a coated substrate (200) comprising a first substrate (201) coated with the optical filter coating (205) configured with a specific spectral sensitivity;
forming (102) a substrate stack (300) by disposing (104) a second substrate (302) over the optical filter coating (205) of the coated substrate (200) such that the optical filter coating (205) forms an interlayer between the first substrate (201) and the second substrate (302);
dicing (103) the substrate stack (300) into a plurality of separated, individual portions (400a-400d), each portion (400a-400d) comprising a diced part (200′) of the coated substrate (200) and a diced part (302′) of the second substrate (302) with a diced part (205′) of the optical filter coating (205) as an interlayer in between the diced part (201′) of the first substrate (201) and the diced part (302′) of the second substrate (302).
   Clause 2] Method (100) for manufacturing an optical filter (401′), the method (100) comprising the steps of:
providing (101) a coated substrate (200) comprising a first substrate (201) coated with an optical filter coating (205) configured with a specific spectral sensitivity;
forming (102) a substrate stack (300) by disposing (104) a second substrate (302) over the optical filter coating (205) of the coated substrate (200) such that the optical filter coating (205) forms an interlayer between the first substrate (201) and the second substrate (302);
dicing (103) the substrate stack (300) into a plurality of separated, individual portions (400a-400d), each portion (400a-400d) comprising a diced part (200′) of the coated substrate (200) and a diced part (302′) of the second substrate (302) with a diced part (205′) of the optical filter coating (205) as an interlayer in between the diced part (201′) of the first substrate (201) and the diced part (302′) of the second substrate (302), each portion providing basis for an optical filter.
   Clause 3] Method according to one of the clauses 1-2,
   wherein the step of providing a coated substrate comprises the steps (104) of:
providing a first substrate (201); and
applying an optical filter coating (205) on the first substrate (201) to obtain a coated substrate (200).
   Clause 4] Method according to any one of the preceding clauses,
   wherein the specific spectral sensitivity is configured for allowing passage of optical radiation at predefined wavelengths and preventing passage of optical radiation having wavelengths other than the predefined wavelengths.
   Clause 5] Method according to any one of the preceding clauses,
   wherein the optical filter coating is a stack of a plurality of coating layers.
   Clause 6] Method (100) according to any one of the preceding clauses, wherein the step of forming a substrate stack comprises attaching (105), such as adhering, the second substrate (302) onto the optical filter coating (205).
   Clause 7] Method (100) according to any one of the preceding clauses, wherein the first substrate (201) and the second substrate (302) differ from each other in at least one of a thickness, a material and a density.
   Clause 8] Method (100) according to any one of the preceding clauses, comprising that, after the step of dicing (105), the diced part (302′) of the second substrate (302) is removed (106) from the separated, individual portion (400a-400d).
   Clause 9] Method (100) according to any one of the preceding clauses, wherein at least one of the first substrate (201) and the second substrate (302) is optical transparent for radiation in the range of 150-2500 nm, such as in the range of 200-1100 nm.
   Clause 10] Method (100) according to any one of the preceding clauses, comprising the step of chamfering (107) one or more outer edges (501) of one or more of the plurality of individual portions (400a-400d).
   Clause 11] Method according to any of the preceding clauses, comprising the step of removing at least one of the separated, individual portions.
   Clause 12] Method (100) according to any one of the preceding clauses,
   wherein the first substrate has a coating side facing to the optical filter coating and an opposing side facing away from the coating side;
   wherein the method further comprises the steps of:
adhering (103), before the step of dicing the substrate stack (300), the opposing side of the first substrate (201) on a continuous carrier layer (600),
maintaining, during the step of dicing (105) of the substrate stack (300), the continuity of the carrier layer (600),
removing at least one of the separated, individual portions (400a-400d) from the carrier layer (600).
   Clause 13] Method according to any of the preceding clauses,
   wherein the method further comprises the steps of:
determining whether
   one or more of the individual portions, or
   the optical filter coating of one or more of the individual portions meet a predefined design requirement associated to the specific spectral sensitivity;
labelling a said individual portions meeting the predefined design requirement as a ‘good portion’; and
removing one or more of the ‘good portions’ from the individual portions.
   Clause 14] Method according to any of the preceding clauses,
   wherein the method further comprises the steps of:
determining where the coated substrate meets a predefined design requirement associated to the specific spectral sensitivity, and.
labelling an area of the coated substrate as a ‘good area’ when the coated substrate meets the predefined optical design requirement in the respective area;
labelling the individual portions originating from a ‘good area’ as ‘good portions’;
removing one or more of the ‘good portions’ from the individual portions.
   Clause 15] Method (100) according to any one of clauses 11-14, wherein the step of removing comprises using a pick-and-place machine gripping the individual portion respectively ‘good portion’ to be removed.
   Clause 16] Method (100) according to any one of the clauses 11-15, comprising the step of attaching (108) the removed individual portion respectively removed ‘good portion’ (400a-400d) to a filter frame (803).
   Clause 17] Method for manufacturing an optical measurement device comprising one or more optical sensors, such as photodiodes and/or phototransistors, and one or more individual portions obtained by a method according to one of the preceding clauses, wherein the method comprises attaching and aligning the one or more optical sensors to the one or more individual portions such that radiation impinging on each of the optical sensors must have passed through a said filter aligned with the impinged sensor.
   Clause 18] Optical filter system (802) comprising a plurality of optical filters, each of the optical filters being formed by at least a part of a said individual portion obtained by a method according to one of the clauses 1-16.
   Clause 19] Optical filter system according to clause 18, further comprising a filter frame, the plurality of optical filters being attached to the filter frame and arranged in an array.
   Clause 20] The optical filter system (802) according to one of the clauses 18-19, wherein each optical filter (400b′-d′) has a specific spectral sensitivity different from the spectral sensitivities of the other optical filters.
   Clause 21] Optical measurement device (800) comprising an optical filter system (802) according to one of the clauses 18-20, and a plurality of optical sensors (811a-d), such as photodiodes and/or phototransistors,
   wherein the each said optical sensors is aligned with and attached to one of the optical filters of the optical filter system such that radiation impinging on each of the optical sensors must have passed through the filter aligned with the impinged sensor.
   Clause 22] Optical measurement device (800) according to clause 16, comprising at least X optical filters and at least X optical sensors, X being 64 or more such as 256 or more.
   Clause 23] Optical measurement device (800) according to any one of clauses 21-22, wherein the optical measurement device (800) is a colorimeter.
   Clause 24] Use of the optical measurement device (800) according to one of the clauses 16-20 for measuring a color or colors of an object (820).
   Clause 25] Use according to clause 24, wherein the object (820) has a display (821) irradiating the color(s). This document describes detailed embodiments of the invention. However it must be understood that the disclosed embodiments serve exclusively as examples, and that the invention may be implemented in other forms.

1. A method for dicing a substrate coated with an optical filter coating, the method comprising the steps of:
providing a coated substrate comprising a first substrate coated with the optical filter coating configured with a specific spectral sensitivity;
forming a substrate stack by disposing a second substrate over the optical filter coating of the coated substrate such that the optical filter coating forms an interlayer between the first substrate and the second substrate;
dicing the substrate stack into a plurality of separated, individual portions, each portion comprising a diced part of the coated substrate and a diced part of the second substrate with a diced part of the optical filter coating as an interlayer in between the diced part of the first substrate and the diced part of the second substrate,
wherein the method further comprises the steps of:
determining where the coated substrate meets a predefined design requirement associated to the specific spectral sensitivity, and
labelling an area of the coated substrate as a ‘good area’ when the coated substrate meets the predefined optical design requirement in the respective area;
labelling the individual portions originating from a ‘good area’ as ‘good portions’;
removing one or more of the ‘good portions’ from the plurality of separated, individual portions.

2. (canceled)

3. The method according to claim 1, wherein the dicing is according to a predefined pattern, and wherein the labelling of individual portions as ‘good portions’ takes place before, during, or after the step of dicing on the basis of information about the position of the substrate stack relative to the predefined pattern.

4. The method according to claim 1, wherein the steps of determining and labelling an area take place before the dicing step.

5. The method according to claim 1,
wherein the first substrate has a coating side facing to the optical filter coating and an opposing side facing away from the coating side;
wherein the method further comprises the steps of:
adhering, before the step of dicing the substrate stack, the opposing side of the first substrate on a continuous carrier layer,
maintaining, during the step of dicing of the substrate stack, the continuity of the carrier layer,
removing at least one of the separated, individual portions from the carrier layer.

6. The method according to claim 1, wherein the step of removing comprises using a pick-and-place machine gripping the ‘good portion’ to be removed.

7. The method according to claim 1, wherein the step of providing a coated substrate comprises the steps of:
providing a first substrate; and
applying an optical filter coating on the first substrate to obtain a coated substrate.

8. The method according to claim 1, wherein the specific spectral sensitivity is configured for allowing passage of optical radiation at predefined wavelengths and preventing passage of optical radiation having wavelengths other than the predefined wavelengths.

9. The method according to claim 1, wherein the optical filter coating is a stack of a plurality of coating layers.

10. The method according to claim 1, wherein the step of forming a substrate stack comprises attaching, such as adhering, the second substrate onto the optical filter coating.

11. The method according to claim 1, wherein the first substrate and the second substrate differ from each other in at least one of a thickness, a material and a density.

12. The method according to claim 1, comprising that, after the step of dicing, the diced part of the second substrate is removed from the separated, individual portion.

13. The method according to claim 1, wherein at least one of the first substrate and the second substrate is optical transparent for radiation in the range of 150-2500 nm, such as in the range of 200-1100 nm.

14. The method according to claim 1, comprising the step of chamfering one or more outer edges of one or more of the plurality of individual portions.

15. The method according to claim 1, comprising the step of removing at least one of the separated, individual portions.

16. The method according to claim 1, wherein the method further comprises the steps of:
determining whether
one or more of the individual portions, or
the optical filter coating of one or more of the individual portions meet a predefined design requirement associated to the specific spectral sensitivity;
labelling a said individual portions meeting the predefined design requirement as a ‘good portion’; and
removing one or more of the ‘good portions’ from the individual portions.

17. The method according to claim 1, comprising the step of attaching the removed individual portion respectively removed ‘good portion’ to a filter frame.

18. A method for manufacturing an optical measurement device comprising one or more optical sensors, such as photodiodes and/or phototransistors, and one or more individual portions obtained by a method according to one of the preceding claims, wherein the method comprises attaching and aligning the one or more optical sensors to the one or more individual portions such that radiation impinging on each of the optical sensors must have passed through a said filter aligned with the impinged sensor.

19. An optical filter system comprising a plurality of optical filters, each of the optical filters being formed by at least a part of a said individual portion obtained by a method according to claim 1.

20. The optical filter system according to claim 19, further comprising a filter frame, the plurality of optical filters being attached to the filter frame and arranged in an array.

21. The optical filter system according to claim 19, wherein each optical filter has a specific spectral sensitivity different from the spectral sensitivities of the other optical filters.

22. An optical measurement device comprising an optical filter system according to claim 19, and a plurality of optical sensors, such as photodiodes and/or phototransistors,
wherein the each said optical sensors is aligned with and attached to one of the optical filters of the optical filter system such that radiation impinging on each of the optical sensors must have passed through the filter aligned with the impinged sensor.

23. The optical measurement device according to claim 22, comprising at least X optical filters and at least X optical sensors, X being 64 or more such as 256 or more.

24. The optical measurement device according to claim 22, wherein the optical measurement device is a colorimeter.

25. A use of the optical measurement device according to claim 22 for measuring a color or colors of an object.

26. The use according to claim 25, wherein the object has a display irradiating the color(s).
